(19) United States
(12) Patent Application Publication
(10) Pub. No.: US 2005/0246214 A1
(43) Pub. Date: Nov. 3, 2005

(54) Method/process for monitoring the progress of six sigma projects during implementation

(76) Inventor: Mahesh Chinnagiri, Bangalore (IN)

Correspondence Address: MAHESH CHINNAGIRI;s/o Prof. C.A. SETTY, No. 85, 2ND FLOOR, 9TH CROSS, RAJAMAHAL VILAS EXTENSION, BANGALORE, 560080, IN

(21) Appl. No.: 11/063,306

(22) Filed: Feb. 23, 2005

Related U.S. Application Data
(60) Provisional application No. 60/546,257, filed on Feb. 23, 2004.

(51) Int. Cl. G06F 19/00

(52) U.S. Cl. 705/7; 702/83

(57) ABSTRACT

Six Sigma is practiced as a methodology of process improvement to achieve business excellence by Companies all over the world today. The inventor Mr. Mahesh Chinnagiri addresses the present fallacy during Six Sigma implementation namely; Method of calculating “Sigma Level”/“Sigma Rating” for any project at any given point of time to monitor performance. There are two methods namely “The Discrete Method” and “The Continuous Method” for calculating the performance in terms of the Sigma Level at any given point of time for a Six Sigma project. The inventor has found out that fallacy exists in the “Continuous Method” of calculation. The inventor after finding out the fallacy in the present method used all over the world, has invented the “Capability Measurement Diagram” and “Moving Loss” method and built them into his “Capability Measurement Software” which can be used to monitor the progress of Six Sigma/other projects during implementation to overcome the above fallacy. The inventor is a consultant/trainer to various industries (Software, Manufacturing as well as Service industries) for implementation of Six Sigma, Total Quality Management, ISO 9001, World Class Manufacturing and allied Quality Management initiatives. He has published and presented papers in various National and International Journals, Research Seminars and Conferences.

### CROSS-REFERENCE TO RELATED APPLICATIONS

PROVISIONAL PATENT U.S. APPLICATION No. 60/546,257
PROVISIONAL PATENT FILING DATE: Feb. 23, 2004
NAME OF THE APPLICANT/INVENTOR: MAHESH CHINNAGIRI
FOREIGN FILING LICENSE GRANTED: Jun. 8, 2004
PROVISIONAL APPLICATION CONFIRMATION NO.: 7236
APPLICANT STATUS: SMALL ENTITY

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Number of Compact Discs enclosed with this application: 2
Machine Format: IBM-PC
Operating System Compatibility: MS-DOS and MS-Windows

### CONTENTS OF THE COMPACT DISCS

Both the Compact Discs are identical and contain a Main Folder called “Capability Measurement” Folder, which in turn contains 3 Folders and 1 File as given below:

| Sl. | Folder/File | Folder/ | Contents of Folder/ | | | Creation |
|---|---|---|---|---|---|---|
| No. | Name | File | File | Size | | Date |
| 1. | Java Class Files | Folder | Compiled Java Class files | 75 | KB | 02/14/2005 |
| | | | for running the Capability | | | |
| | | | Measurement Software. | | | |
| 2. | Java Code Files | Folder | Java Code files containing | 98.1 | KB | 02/14/2005 |
| | | | the complete Code for the | | | |
| | | | Capability Measurement | | | |
| | | | Software. | | | |
| 3. | JAVA SOFTWARE | Folder | Downloaded Java JDK | 58.2 | MB | 02/15/2005 |
| | JDK 1.3.1 | | 1.3.1 for Windows on | | | |
| | | | which the Capability | | | |
| | | | Measurement Software | | | |
| | | | can be run. | | | |
| 4. | README | File | Instructions/Methods for | 1.71 | KB | 02/16/2005 |
| | | | running the Capability | | | |
| | | | Measurement Software. | | | |

Contents of the “Java Code Files” Folder with the names of Files, Size and Creation Date are given below:

| Sl. No. | File Name | Size | | Creation Date |
|---|---|---|---|---|
| 1. | AddressPage$1.class | 1 | KB | 02/15/2005 |
| 2. | AddressPage.class | 4 | KB | 02/15/2005 |
| 3. | CapMeasurement.class | 12 | KB | 02/15/2005 |
| 4. | DisGraph1$1.class | 1 | KB | 02/15/2005 |
| 5. | DisGraph1$2.class | 1 | KB | 02/15/2005 |
| 6. | DisGraph1.class | 5 | KB | 02/15/2005 |
| 7. | DisGraph2$1.class | 1 | KB | 02/15/2005 |
| 8. | DisGraph2$2.class | 1 | KB | 02/15/2005 |
| 9. | DisGraph2.class | 5 | KB | 02/15/2005 |
| 10. | Graph1.class | 6 | KB | 02/15/2005 |
| 11. | Graph2.class | 7 | KB | 02/15/2005 |
| 12. | GraphTable1$1.class | 1 | KB | 02/15/2005 |
| 13. | GraphTable1.class | 8 | KB | 02/15/2005 |
| 14. | GraphTable2$1.class | 1 | KB | 02/15/2005 |
| 15. | GraphTable2.class | 7 | KB | 02/15/2005 |
| 16. | MultiLineHeaderRenderer.class | 2 | KB | 02/15/2005 |
| 17. | OutputTable1$1.class | 1 | KB | 02/15/2005 |
| 18. | OutputTable1$2.class | 1 | KB | 02/15/2005 |
| 19. | OutputTable1$3.class | 1 | KB | 02/15/2005 |
| 20. | OutputTable1.class | 6 | KB | 02/15/2005 |
| 21. | OutputTable2$1.class | 1 | KB | 02/15/2005 |
| 22. | OutputTable2$2.class | 1 | KB | 02/15/2005 |
| 23. | OutputTable2$3.class | 1 | KB | 02/15/2005 |
| 24. | OutputTable2.class | 7 | KB | 02/15/2005 |
| 25. | TableParam$1.class | 1 | KB | 02/15/2005 |
| 26. | TableParam.class | 4 | KB | 02/15/2005 |

Contents of the “Java Code Files” Folder with the names of Files, Size and Creation Date are given below:

| Sl. No. | File Name | Size | | Creation Date |
|---|---|---|---|---|
| 1. | AddressPage | 4 | KB | 02/16/2005 |
| 2. | CapMeasurement | 19 | KB | 02/14/2005 |
| 3. | DisGraph | 5 | KB | 02/14/2005 |
| 4. | DisGraph1 | 5 | KB | 02/14/2005 |
| 5. | DisGraph2 | 6 | KB | 02/14/2005 |
| 6. | Graph1 | 10 | KB | 02/13/2005 |
| 7. | Graph2 | 13 | KB | 02/13/2005 |
| 8. | GraphTable1 | 10 | KB | 02/13/2005 |
| 9. | GraphTable2 | 9 | KB | 02/13/2005 |
| 10. | MultiLineHeaderRenderer | 2 | KB | 01/26/2005 |
| 11. | OutputTable1 | 8 | KB | 02/15/2005 |
| 12. | OutputTable2 | 9 | KB | 02/15/2005 |
| 13. | TableParam | 4 | KB | 02/04/2005 |

Contents of the “JAVA SOFTWARE JDK 1.3.1” Folder with the names of Files, Size and Creation Date are not given since, the “JAVA SOFTWARE JDK 1.3.1” folder contains basically the downloadable Java JDK 1.3.1 Software for Windows Platform on which the Capability Measurement Software can be run. The “JAVA SOFTWARE JDK 1.3.1” Folder contains in total 115 Folders and 712 Files with the Java JDK 1.3.1 Software consisting 115 folders and 686 files. The applicant has copied the 26 Java Class Files in to the “bin” Folder (one of the 115 folders) for running the “Capability Measurement Software” using Method 2 (given under the “Instructions for running the Capability Measurement Software”). Hence we have a total of 115 folders and 712 files (686 Files+26 Files). As already mentioned, “Java JDK 1.3.1 Software” is standard software available, and hence its folders and files are not listed. However, file names, size and creation date of the 26 Java Class Files is already given above.
The “README” File in the Main Folder on the Compact Disc (Size 1.71 KB; Created on Feb. 16, 2005) contains instructions/methods for running the “Capability Measurement Software”.

### INSTRUCTIONS FOR RUNNING IHE “CAPABILITYMEASUREENT SOFTWARE”

Method 1:

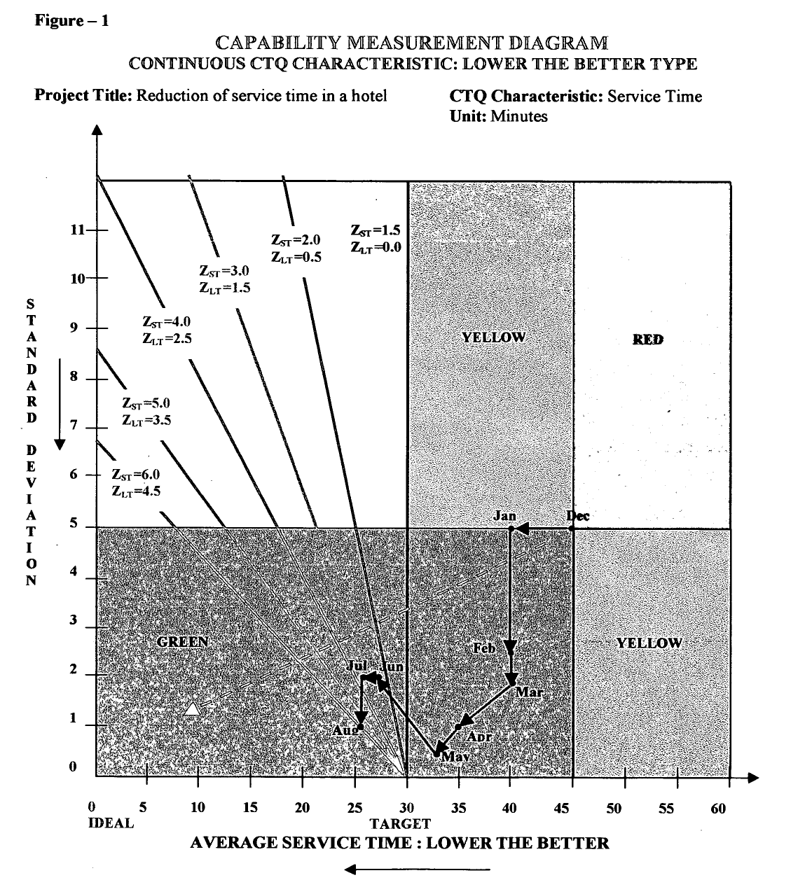

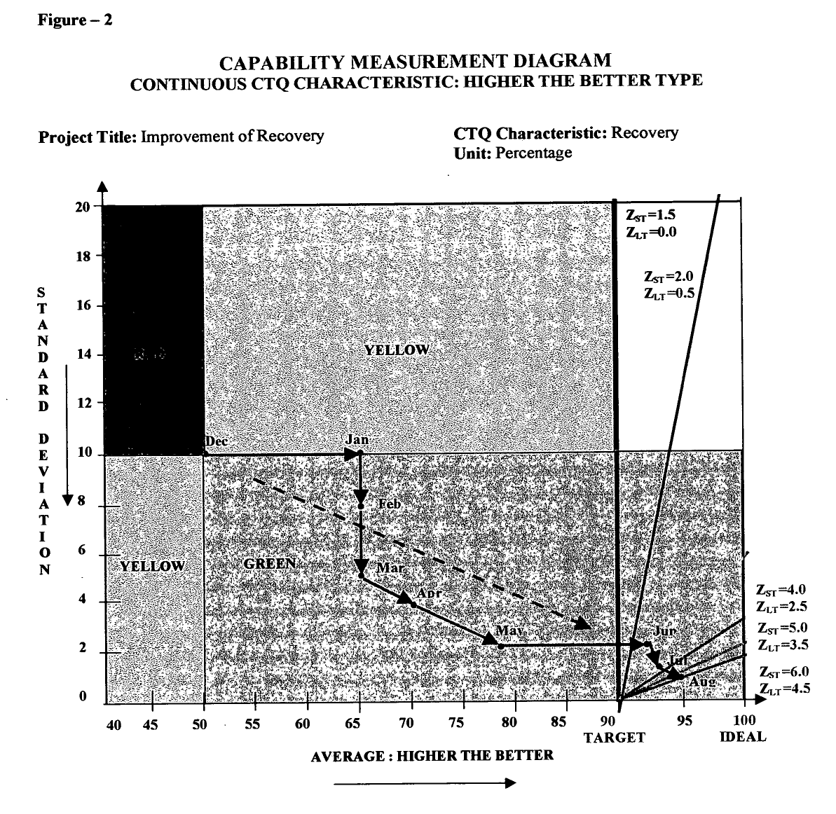

A. DOWNLOAD JAVA VERION 1.3 FOR WINDOWS
B. COPY ALL CLASS FILES TO THE BIN FOLDER IN THE DOWNLOADED JAVA SOFTWARE
C. IN THE DOS PROMPT GO TO BIN FOLDER
D. TYPE java AddressPage AND PRESS ENTER
E. PRESS CONTINUE BUTTON ON THE INITIAL SCREEN
F. SELECT DISCRETE OR CONTINUOUS ON THE INPUT SCREEN
G. IF DISCRETE IS SELECTED THEN SELECT EITHER DEFECTS OR DEFECTIVES
H. IF CONTINUOUS IS SELECTED THEN SELECT EITHER LOWER THE BETTER OR HIGHER THE BETTER OR NOMINAL THE BEST
I. YOU ARE READY TO INPUT YOUR DATA
J. PRESS OK BUTTON AT THE BOTTOM TO GET OUTPUT SCREEN
K. PRESS OK TO EXIT OUTPUT SCREEN
L. IF YOU WISH TO CONTINUE WITH ANOTHER DATA SET REPEAT FROM STEP D.
   Method 2:
A. IN THE DOS PROMPT GO TO “BIN” FOLDER IN “JAVA SOFTWARE JDK 1.3.1” FOLDER ON THE CD
B. TYPE java AddressPage AND PRESS ENTER
C. PRESS CONTINUE BUTTON ON THE INITIAL SCREEN
D. SELECT DISCRETE OR CONTINUOUS ON THE INPUT SCREEN
E. IF DISCRETE IS SELECTED THEN SELECT EITHER DEFECTS OR DEFECTIVES
F. IF CONTINUOUS IS SELECTED THEN SELECT EITHER LOWER THE BETTER OR HIGHER THE BETTER OR NOMINAL THE BEST
G. YOU ARE READY TO INPUT YOUR DATA
H. PRESS OK BUTTON AT THE BOTTOM TO GET OUTPUT SCREEN
I. PRESS OK TO EXIT OUTPUT SCREEN
J. IF YOU WISH TO CONTINUE WITH ANOTHER DATA SET REPEAT FROM STEP B.
   The Capability Measurement Software (on Compact Disc) is very useful in depicting instantaneously the Applicant's Invention namely “Capability Measurement Diagram” (similar to FIG. 1 or FIG. 2) and the associated “Moving Loss” values, for data on “Six Sigma Projects” with “Critical to Quality Characteristics” of Continuous type (Higher/Lower the better type). Software avoids the need for drawing and calculating manually Applicant's Invention namely “Capability Measurement Diagram” and “Moving Loss”.

### BACKGROUND OF THE INVENTION

Quality has been the focus of every organization, more so in the present scenario of intense competition worldwide. Companies are using several routes to excel in the competition. Quality route has been the choice of a few enlightened companies but of late, has been recognized as panacea for all ailments! Six Sigma, Total Quality Management etc. are various approaches adopted by organizations to achieve business excellence by focusing on Quality.

Six Sigma is practiced as a methodology of process improvement to achieve business excellence and strengthen stockholders share value. Six Sigma is a systematic method of using extremely rigorous data gathering and statistical analysis. It also helps in developing corporate strategy and bringing about organizational change by aligning people and processes. The practice of Six Sigma takes the form of projects conducted in phases generally recognized as DMAIC (Define-Measure-Analyze-Improve-Control) or DFSS (Design for Six Sigma).

The inventor addresses the present fallacy during Six Sigma implementation namely; Method of calculating “Sigma Level”/“Sigma Rating” for any project at any given point of time to monitor performance.

There are two methods namely “The Discrete Method” and “The Continuous Method” for calculating the performance in terms of the Sigma Level at any given point of time for a Six Sigma project. The inventor has found out that fallacy exists in the Continuous Method of calculation. The inventor has invented a new methods/processes called “Capability Measurement Diagram” and the “Moving Loss” to overcome the present fallacy. Based on this the Inventor has also developed a Software called “Capability Measurement Software”.

### BRIEF SUMMARY OF THE INVENTION

As mentioned above the inventor is addressing the fallacy in the present method of calculating “Sigma Level”/“Sigma Rating” for any project at any given point of time to monitor performance. The inventor has found out that fallacy exists in the Continuous Method of calculation used all over the world.

The inventor has invented new methods/processes called “Capability Measurement Diagram” and the “Moving Loss” to overcome the present fallacy. The inventor has developed a Computer Software incorporating the new methods/processes for monitoring the progress of six sigma projects during six sigma implementation called “CAPABILITY MEASUREMENT SOFTWARE” with output in the form of “CAPABILITY MEASUREMENT DIAGRAM” and “MOVING LOSS”. The software/diagram in short is called the “CM—SOFTWARE”/“CM—DIAGRAM” named after the inventor.

The CAPABILITY MEASUREMENT SOFTWARE can be used to monitor the progress of Six Sigma projects/other projects instead of the present fallacious method. This alternative novel method is described in detail in this Non Provisional Application for Patent.

### BRIEF DESCRIPTION OF THE SEVERAL VIEWS OF THE DRAWINGS

The following diagrams (necessary to impart better understanding of the concepts) are used in this Non-Provisional Application:

FIG. 1: Capability Measurement Diagram for Continuous CTQ Characteristic:
“Lower The Better Type”

FIG. 2: Capability Measurement Diagram for Continuous CTQ Characteristic:
“Higher The Better Type”

### DETAILED DESCRIPTION OF THE INVENTION

Six Sigma is a powerful strategy for achieving breakthrough results. Six Sigma can add to the bottom line by improving processes and reducing errors. Six Sigma initiative in accompany will be successful when there is Management commitment, involvement & support, treating Six Sigma as a holistic approach, investing adequate resources, focusing on customer requirements, usage of appropriate tools and techniques. Customer satisfaction is the key to success of any business today and in the future.

The inventor has identified the following fallacy during implementation of Six Sigma projects.

Fallacy: Method to calculate the Sigma Level/Sigma Rating for any Six Sigma Project:

There are two methods namely “The Discrete Method” and “The Continuous Method” for calculating the performance in terms of the Sigma Level at any given point of time for a Six Sigma project. The inventor has found out that fallacy exists in the Continuous Method of calculation.

Generally, the target (say “T”) is fixed for a given project depending on the project objective. For example, the target for repair time to a customer call may be fixed as maximum 24 hours or lead-time of new product development may be fixed as maximum 45 working days or target for yield may be fixed as minimum 90%. Both, the first and second cases are, lower the better type and the last case is of higher the better type.
Sigma Level/Sigma Rating is denoted by “Z”. Long term Sigma Level/Sigma Rating is denoted by Zₗₜ and Short term Sigma Level/Sigma Rating is denoted by Zₛₜ.
Zₗₜ=(Target−Average)/Standard deviation, when Project objective/CTQ characteristic is of “Lower the better” type having target “Maximum X (say)”.
Zₗₛₜ=(Average−Target)/Standard deviation, when Project objective/CTQ characteristic is of “Higher the better” type having target “Minimum X (say)”.
Also, Zₛₜ=Zₗₜ+1.5 (Short term Sigma Level=Long term Sigma Level+1.5)
   Let us illustrate the fallacy in present method to calculate Sigma Level with the following example for Case: Project objective/CTQ characteristic is of “Lower the better” type having target “Maximum X (say)”.

Let us say the target for the service time to a customer order for food in a hotel is maximum 30 minutes (or target for schedule variance of a software projects is 30%) and the present average is 45 minutes (or 45% in software projects) and the Hotel management (or Software Company) wants to increase the customer satisfaction level by achieving target of maximum 30 minutes (or 30% in software projects) to start with. This Six Sigma project was initiated by forming a team say in January, 2003.

Let us now discuss only about service time to a customer order in a Hotel. The same applies to the Software schedule variance example for software projects in Software Companies.

Data collected for the period October to December 2002 indicated an average of 45 minutes and a Standard deviation of 5 minutes. The base sigma level before the commencement of the project works out to be −1.5 (Short term Sigma Level=Long term Sigma Level+1.5). This is taken as the Base Sigma Level.

Let us assume the team members met regularly and devoted adequate time and resources for the project in identifying weak areas and taking corrective actions. Let us assume the progress of the project team is as given in Table-1 below:

TABLE 1

| Description | Base Level | Jan | Feb | Mar | Apr | May | Jun | Jul | Aug |
|---|---|---|---|---|---|---|---|---|---|
| Average service time | 45 | 40 | 40 | 40 | 35 | 33 | 28 | 26 | 25.5 |
| Standard Deviation | 5 | 5 | 2.5 | 2 | 1 | 0.5 | 2 | 2 | 1 |
| Sigma Level: Zₗₜ | −3.0 | −2.0 | −4.0 | −5.0 | −5.0 | −6.0 | 1.0 | 2.0 | 4.5 |
| Sigma Level: Zₛₜ | −1.5 | −0.5 | −2.5 | −3.5 | −3.5 | −4.5 | 2.5 | 3.5 | 6.0 |

Let us assume the team identified weak areas and took some corrective actions in first week of January, 2003. As a result let us say the average is 40 minutes and the Standard deviation 5 minutes. The sigma level now works out to be −0.5 (short term sigma level).

The team continues its journey in identifying and taking corrective actions. In February, let us assume there is no change in the average value of time to service but there is a reduction in standard deviation to 2.5 as against the value of 5 in January. This is a significant achievement by the team. But the sigma level now works out to be −2.5 (short term sigma level) a lower value as compared to the value of −0.5 in January even though there was a significant improvement in the process namely reduction of the standard deviation or variation.

It is really surprising as to how misleading the present method of calculating sigma level could be to the project team till the average crosses the target. Even though there is a real improvement (reduction of variation) in February as compared to January the Sigma level indicates the contrary. Same is the situation between February and March wherein there is a reduction in variation, but the Sigma level indicates a lower value.

In April, there is reduction in both average time taken as well as variation (standard deviation) as compared to March, but the Sigma level remains same (−3.5) as seen in sketch below. The reason for this is that the area of the distribution of both months on the right and left side of target is the same. Hence the use of discrete method of sigma level calculation to overcome this fallacy is also a gross error and should not be used.

[image]

In May again, there is reduction in both average time taken as well as variation (standard deviation) as compared to April, but the Sigma level has reduced (from −3.5 to −4.5) even though there is a real improvement (reduction of variation from 1 to 0.5 and average service time from 35 to 33) in May as compared to April.

Only from the month June onwards, the Sigma Level reflects the true performance because the average has become less than the target value.

Hence it can be concluded that till the average crosses over (becomes less than) the target, the sigma level is misleading and does not reflect true performance.

Inventor's Novel Methods/Processes to Calculate the Performance for any Project with Project Objective of “Lower the Better” Type Having Target as “Maximum X (Say)”

Method 1: Use of Loss as a Means to Monitor the Progress of Projects

The inventor in his Provisional Application for patent has suggested monitoring performance of the teams/progress of the projects, for cases where project objective is of “Lower the better” type having target as “Maximum X (say)” using the formula
Loss=(Average)²+(Standard Deviation)²

till the average crosses the target to visualize the performance and to use the existing method after the average crosses the target value as shown in table below. The loss for various months are shown in Table-2 and reduction in the loss value indicates process improvement.

TABLE 2

| | Base | | | | | | | | |
|---|---|---|---|---|---|---|---|---|---|
| Description | Level | Jan | Feb | Mar | Apr | May | Jun | Jul | Aug |
| Average time | 45 | 40 | 40 | 40 | 35 | 33 | 28 | 26 | 25.5 |
| Standard | 5 | 5 | 2.5 | 2 | 1 | 0.5 | 2 | 2 | 1 |
| Deviation | | | | | | | | | |
| Loss | 2050 | 1625 | 1606.25 | 1604 | 1226 | 1089.25 | 788 | 680 | 651.25 |
| Sigma Level: Zₗₜ | — | — | — | — | — | — | 1.0 | 2.0 | 4.5 |
| Sigma Level: Zₛₜ | — | — | — | — | — | — | 2.5 | 3.5 | 6.0 |

It can be seen from above table that the loss is continuously reducing from January to May indicating good performance. Once the average has crossed the target value (30 in this case) the normal method of sigma level calculation indicates improvement from June to August.

Hence the inventor in his Provisional Application for Patent strongly suggests the use of his method/process to monitor progress till the average becomes less than the target and then continue with either the present existing method or the method suggested by the inventor. But limitation of this method is that it can be used only when there is a reduction in any one or both the average and standard deviation in any month as compared to the previous month's values and cannot be used in cases where there is an increase in any one that is average or standard deviation and decrease in the other when compared with the previous month's values. To overcome this limitation the inventor suggests the use of method 2 discussed below.

Method 2: Use of Capability Measurement Software Depicting the Capability Measurement Diagram as a Means to Monitor the Progress of Projects

The Applicant or Inventor has invented the “Capability Measurement Diagram” and the related “Moving Loss” to be used to monitor the performance of Six Sigma projects/other projects at any point of time during project progress. Capability Measurement Diagram for “Lower the better type” CTQ Characteristic is shown in FIG. 1.

As seen in the Capability Measurement Diagram example in FIG. 1, the target for the project is 30 minutes (indicated by a solid black color vertical line). Any point on this black color target line indicates a “Long term Sigma Level”, Zlt=0.0 and corresponding “Short term Sigma Level”, Zst=1.5. Similarly the solid blue color line (colors can be seen only in Software Output) indicates a “Long term Sigma Level”, Zlt=0.5 and “Short term Sigma Level”, Zst=2. The solid gray color line indicates a “Long term Sigma Level”, Zlt=1.5 and “Short term Sigma Level”, Zst=3. The solid magenta color line indicates a “Long term Sigma Level”, Zlt=2.5 and “Short term Sigma Level”, Zst=4. The solid pink color line indicates a “Long term Sigma Level”, Zlt=3.5 and “Short term Sigma Level”, Zst=5. The solid red color line indicates a “Long term Sigma Level”, Zlt=4.5 and “Short term Sigma Level”, Zst=6.

Hence as mentioned earlier the Sigma Level is meaningful when the average value becomes less than the target value of 30 minutes in this example of service time (continuous CTQ Characteristic of lower the better type). When the average value is larger than the target value the Sigma Level calculated is misleading and fallacious.

Hence in this region the inventor suggests calculating “Moving Loss” (in terms of area the logic for which is explained in Page 16) to check if there is improvement or not in the CTQ Characteristic/Objective as compared to the corresponding previous month. Reduction in the “Loss value” for any month when compared to the corresponding previous month's “Loss value” indicates improvement.

The logic used by the Inventor in “Moving Loss” calculations when the CTQ Characteristic is of “Lower the better type” is as given below:
a) There will be a reduction in loss value for any month as compared to the corresponding previous month's loss value if there is a reduction in either any one namely “Average” or “Standard deviation” (with the other remaining constant)
b) There will be a reduction in loss value for any month as compared to the corresponding previous month's loss value if there is reduction in both the “Average” and “Standard deviation”.
c) If there is increase in either any one namely “Average” or “Standard deviation” (with the other remaining constant) the loss value for that month will be more as compared to the corresponding previous month's loss value.
d) If there is increase in either any one namely “Average” or “Standard deviation” (with reduction in the other) the loss value for that month will be more as compared to the corresponding previous month's loss value.
e) If there is increase in both the “Average” and the “Standard deviation” the loss value for that month will be more as compared to the corresponding previous month's loss value.

Table-3 shows the “Moving Loss” for different months based on the above logic.

TABLE 3

| | Average | Standard | Sigma Level | Moving |
|---|---|---|---|---|
| Month | Time | Deviation | (Short Term) Zst | Loss |
| Base Level: Dec | 45 | 5 | Not Applicable | 300 |
| Jan | 40 | 5 | Not Applicable | 275 |
| Feb | 40 | 2.5 | Not Applicable | 250 |
| Mar | 40 | 2 | Not Applicable | 245 |
| Apr | 35 | 1 | Not Applicable | 230 |
| May | 33 | 0.5 | Not Applicable | 226.5 |
| Jun | 28 | 2 | 2.5 | 196.875 |
| Jul | 26 | 2 | 3.5 | 168.75 |
| Aug | 25.5 | 1 | 6.0 | 100 |

Also as seen in FIG. 1, with reference to the first month's (December in this example) parameter values namely Average service time of 45 minutes and a Standard deviation of 5 minutes, there are three colored regions namely red, yellow and green. When compared with the first month's point (December in this example), all points in the red and yellow regions (representing increase in both or any one of the average and standard deviation respectively) indicates process deterioration. When compared with the first month's point (December in this example), all points in the green region (representing decrease in any one with the other remaining constant or reduction in both the average and standard deviation) indicates process improvement. The thick broken line represents the desired direction of improvement.

Logic Used in Drawing The Capability Measurement Diagram and Moving Loss Calculations when Continuous CTQ Characteristic Objective of Interest is of Lower the Better Type

Notations Used:

Target Value: TV
Ideal Value: IV=0.0
1^{st} Month Average: AVG1
2^{nd} Month Average AVG2
. . . and so on till
12^{th} Month Average: AVG12
Lowest Average Value in the data: AVG-Lowest
Highest Average Value in the data: AVG-Highest
Minimum Average value on X-Axis: AVG-Min
Maximum Average value on X-Axis: AVG-Max
1^{st} Month Standard Deviation: SD1
2^{nd} Month Standard Deviation: SD2
. . . and so on till
12^{th} Month Standard Deviation: SD12
Lowest Standard Deviation Value in the data: SD-Lowest
Highest Standard Deviation Value in the data: SD-Highest
Minimum Standard Deviation Value on Y-Axis: SD-Min
Maximum Standard Deviation Value on Y-Axis: SD-Max
Average at SD-Max equivalent to Sigma Level of 2 (Zlt=0.5; Zst=2): AVG-SL2
Average at SD-Max equivalent to Sigma Level of 3 (Zlt=1.5; Zst=3): AVG-SL3
Average at SD-Max equivalent to Sigma Level of 4 (Zlt=2.5; Zst=4): AVG-SL4
Average at SD-Max equivalent to Sigma Level of 5 (Zlt=3.5; Zst=5): AVG-SL5
Average at SD-Max equivalent to Sigma Level of 6 (Zlt=0.5; Zst=6): AVG-SL6
Standard Deviation at Ideal Value (IV) equivalent to Sigma Level of 2 (Zlt=0.5;Zst=2): SD-SL2
Standard Deviation at Ideal Value (IV) equivalent to Sigma Level of 3 (Zlt=0.5;Zst=3): SD-SL3
Standard Deviation at Ideal Value (IV) equivalent to Sigma Level of 4 (Zlt=2.5;Zst=4): SD-SL4
Standard Deviation at Ideal Value (IV) equivalent to Sigma Level of 5 (Zlt=3.5;Zst=5): SD-SL5
Standard Deviation at Ideal Value (IV) equivalent to Sigma Level of 6 (Zlt=4.5;Zst=6): SD-SL6
Loss calculated for the 1^{st} Month: Loss-1
Loss calculated for the 2^{nd} Month: Loss-2
Loss calculated for the Ith Month: Loss-(I)
Long term Sigma Level for 1^{st} Month: Zlt-1
Short term Sigma Level for 1^{st} Month: Zst-1
Long term Sigma Level for 2^{nd} Month: Zlt-2
Short term Sigma Level for 2^{nd} Month: Zst-2
Long term Sigma Level for Ith Month: Zlt-(I)
Short term Sigma Level for Ith Month: Zst-(I)
Average at SD-Max equivalent to 1^{st} Month Data: AVGHigh1
Average at SD-Max equivalent to 2^{nd} Month Data: AVGHigh2
Average at SD-Max equivalent to Ith Month Data: AVGHigh(I)
Standard Deviation at Ideal Value (IV) equivalent to 1^{st} Month Data: SDHigh1
Standard Deviation at Ideal Value (IV) equivalent to 2^{nd} Month Data: SDHigh2
Standard Deviation at Ideal Value (IV) equivalent to Ith Month Data: SDHigh(I)
   Method Used in Drawing the Capability Measurement Diagram
Find out lowest Average value from data entered and denote it as AVG-Lowest
Find out highest Average value from data entered and denote it as AVG-Highest
Find out lowest Standard Deviation value from data entered and denote it as SD-lowest
Find out highest Standard Deviation value from data entered and denote it as SD-Highest
AVG-Max=1.25×AVG-Highest
AVG-Min=IV(Ideal Value)=0.0
Draw X-Axis with origin point as AVG-Min and highest point equal to AVG-Max
SD-Max=2×SD-Highest
SD-Min=0.0
Draw Y-Axis with origin point as SD-Min and highest point equal to SD-Max
Show the graduations on both the X-Axis and Y-Axis
Draw a vertical line at X-Axis point AVG-Max and horizontal line at Y-Axis at SD-Max to obtain the boundary box
Draw a vertical line (Red Color) at X-Axis point TV till it meets the upper horizontal boundary line and denote it as Zlt=0 and Zst=1.5
AVG-SL2=TV−0.5×SD-Max
If AVG-SL2>0.0 OR AVG-SL2=0.0 then
Draw an inclined vertical line joining X-Axis point TV and AVG-SL2 (at SD-Max) and denote it asZlt=0.5 and Zst=2.0
Else If AVG-SL2<0.0 then
SD-SL2=(SD-Max/(0.5×SD-Max))×(TV-IV)
Draw an inclined vertical line joining X-Axis point TV and SD-SL2 (at Ideal Value) and denote it as Zlt=0.5 and Zst=2.0
AVG-SL3=TV−1.5×SD-Max
If AVG-SL3>0.0 OR AVG-SL3=0.0 then
Draw an inclined vertical line joining X-Axis point TV and AVG-SL3 (at SD-Max) and denote it as Zlt=1.5 and Zst=3.0
Else If AVG-SL3<0.0 then
SD-SL3=(SD-Max/(1.5×SD-Max))×(TV-IV)
Draw an inclined vertical line joining X-Axis point TV and SD-SL3 (at Ideal Value) and denote it as Zlt=1.5 and Zst=3.0
AVG-SL4=TV−2.5×SD-Max
If AVG-SL4>0.0 OR AVG-SL4=0.0 then
Draw an inclined vertical line joining X-Axis point TV and AVG-SL4 (at SD-Max) and denote it as Zlt=2.5 and Zst=4.0
Else If AVG-SL4<0.0 then SD-SL4=(SD-Max/(2.5×SD-Max))×(TV-IV)
Draw an inclined vertical line joining X-Axis point TV and SD-SL4 (at Ideal Value) and denote it as Zlt=2.5 and Zst=4.0
AVG-SL5=TV−3.5×SD-Max
If AVG-SL5>0.0 OR AVG-SL5=0.0 then
Draw an inclined vertical line joining X-Axis point TV and AVG-SL5 (at SD-Max) and denote it as Zlt=3.5 and Zst=5.0
Else If AVG-SL5<0.0 then
SD-SL5=(SD-Max/(3.5×SD-Max))×(TV-IV)
Draw an inclined vertical line joining X-Axis point TV and SD-SL5 (at Ideal Value) and denote it as Zlt=3.5 and Zst=5.0
AVG-SL6=TV−4.5×SD-Max
If AVG-SL6>0.0 OR AVG-SL6=0.0 then
Draw an inclined vertical line joining X-Axis point TV and AVG-SL6 (at SD-Max) and denote it as Zlt=4.5 and Zst=6.0
Else If AVG-SL6<0.0 then
SD-SL6=(SD-Max/(4.5×SD-Max))×(TV-IV)
Draw an inclined vertical line joining X-Axis point TV and SD-SL6 (at Ideal Value) and denote it as Zlt=4.5 and Zst=6.0
   Method of Plotting The Input Data Points on Diagram
Mark a point at AVG1 & SD1 and name it as 1^{st} Month (Say May if it is entered as first month in input screen)
Mark a point at AVG2 & SD2 and name it as 2^{nd} Month (Say June if it is entered as second month in input screen)
. . . and so on till
the last month is entered in input screen.
   Join all the points joining from the first month till the last month.
   Logic Used in Moving Loss Calculation for Different Months
   For 1^{st} Month Data:
If AVG1>TV then
Loss-1=(SD-Max×TV)+(AVG1-TV)×SD1
   Else If AVG1=TV then
Zlt-1=0.0; Zst-1=1.5 and
Loss-1=(SD-Max×TV)
Else If AVG1<TV then
BEGIN
   Zlt-1=(TV-AVG1)/SD1 and
   Zst-1=Zlt-1+1.5 and
   AVGHigh1=TV-Zlt-1×SD-Max and
   If AVGHigh1>0.0 OR AVGHigh1=0.0 then
   Loss-1=(SD-Max×TV)−(0.5×(TV-AVGHigh1)×SD-Max)
   Else If AVGHigh1<0.0
   SDHigh1=(SD-Max/(Zlt-1×SD-Max))×(TV-IV) and
   Loss-1=0.5×SDHigh1×(TV-IV)
END.
   For 2nd Month Data:
If AVG2>TV and AVG1<TV OR AVG1=TV then
Loss-2=(SD-Max×TV)+(AVG2-TV)×SD2
Else If AVG2>TV and AVG2=AVG1 then
Loss-2=(SD-Max×TV)+(AVG2-TV)×SD2
Else If AVG2>TV and SD2=SD1 then
Loss-2=(SD-Max×TV)+(AVG2-TV)×SD2
Else If AVG2>AVG1 and AVG1>TV and SD2<SD1 then
Loss-2=Loss-1+(AVG2-AVG1)×SD1−(0.5×(AVG2-AVG1)×(SD1-SD2))
Else If AVG2>AVG and AVG1>TV and SD2>SD1 then
Loss-2=(SD-Max×TV)+((AVG2-TV)×SD2)
Else If AVG2>TV and AVG2<AVG1 and SD2>SD1 then
Loss-2=Loss-1+((SD2-SD1)×(AVG1-TV))−(0.5×(SD2-SD1(TV×IV))×(AVG1-AVG2))
Else If AVG2>TV and AVG2<AVG1 and SD2<SD1 then
Loss-2=(SD-Max×TV)+((AVG2-TV)×SD2)
Else If AVG2=TV then
Zlt-2=0.0; Zst-2=1.5 and
Loss-2=(SD-Max×TV)
Else If AVG2<TV then
BEGIN
   Zlt-2=(TV-AVG2)/SD2 and
   Zst-2=Zlt-2+1.5 and
   AVGHigh2=TV−Zlt-2×SD-Max and
   If AVGHigh2>0.0 OR AVGHigh2=0.0 then
   Loss-2=(SD-Max×TV)−(0.5×(TV−AVGHigh2)×SD-Max)
   Else If AVGHigh2<0.0
   SDHigh2=(SD-Max/(Zlt-2×SD-Max))×(TV-IV) and
   Loss-2=0.5×SDHigh2×(TV-IV)
END.
   For 3^{rd} Month Till last Month Data:
For I=3 TO N DO
If AVG(I)>TV and AVG(I-1)<TV OR AVG(I-1)=TV then
Loss-(I)=(SD-Max×TV)+(AVG(I)−TV)×SD(I)
Else If AVG(I)>TV and AVG(I)=AVG(I-1) then
Loss-(I)=(SD-Max×TV)+(AVG(I)−TV)×SD(I)
Else If AVG(I)>TV and SD(I)=SD(I-1) then
Loss-(I)=(SD-Max×TV)+(AVG(I)−TV)×SD(I)
Else If AVG(I)>AVG(I-1) and AVG(I-1)>TV and SD(I)<SD(I-1) then
Loss-(I)=Loss-(I-1)+(AVG(I)−AVG(I-1))×SD(I-1)(0.5×(AVG(I)−AVG(I-1))×(SD(I-1)−SD(I)))
Else If AVG(I)>AVG(I-1) and AVG(I-1)>TV and SD(I)>SD(I-1) then
Loss-(I)=(SD-Max×TV)+((AVG(I)−TV)×SD(I))
Else If AVG(I)>TV and AVG(I)<AVG(I-1) and SD(I)>SD(I-1) then
Loss-(I)=Loss-(I-1)+((SD(I)−SD(I-1))×(AVG(I-1)−TV))−(0.5×(SD(I)−SD(I-1))×(AVG(I-1)−AVG(I)))
Else If AVG(I)>TV and AVG(I)<AVG(I-1) and SD(I)<SD(I-1) then
Loss-(I)=(SD-Max×TV)+((AVG(I)−TV)×SD(I))
Else If AVG(I)=TV then
Zlt-(I)=0.0; Zst-(I)=1.5 and
Loss-(I)=(SD-Max×TV)
Else If AVG(I)<TV then
BEGIN
   Zlt-(I)=(TV-AVG(I))/SD(I) and
   Zst-(I)=Zlt-(I)+1.5 and
   AVGHigh(I)=TV−Zlt-(I)×SD-Max and
   If AVGHigh(1)>0.0 OR AVGHigh(I)=0.0 then
   Loss-(I)=(SD-Max×TV)−(0.5×(TV−AVGHigh(I))×SD-Max)
   Else If AVGHigh(I)<0.0
   SDHigh(I)=(SD-Max/(Zlt-(I)×SD-Max))×(TV-IV) and
   Loss-(I)=0.5×SDHigh(I)×(TV-IV)
END.
   Let us now illustrate the fallacy in present method to calculate Sigma Level with the following example for Case: Project objective/CTQ characteristic is of “Higher the better” type having target “Minimum X (say)”.

Let us say the target for the recovery of a product in a Company is minimum 90% (or target for right first time modules of software projects be 90%) and the present average recovery is 50% (or average is 50% right first time modules in software projects) and the Company Management (or Software Company) wants to increase the productivity by achieving target of minimum 90% to start with. This Six Sigma project was initiated by forming a team say in January, 2003.

Let us now discuss only about recovery of a product in a Company. The same applies to the % right first time modules example for software projects in Software Companies.

Data collected for the period October to December 2002 indicated an average of 50% recovery and a Standard deviation of 10. The base sigma level before the commencement of the project works out to be −2.5 (short term sigma level). This is taken as the Base Sigma Level. Let us assume the team members met regularly and devoted adequate time and resources for the project in identifying weak areas and taking corrective actions Let us assume the progress of the project team is as given in Table-4 below:

TABLE 4

| | Base | | | | | | | | |
|---|---|---|---|---|---|---|---|---|---|
| Description | Level | Jan | Feb | Mar | Apr | May | Jun | Jul | Aug |
| Average % recovery | 50 | 65 | 65 | 65 | 70 | 78 | 92 | 93 | 94.5 |
| Standard Deviation | 10 | 10 | 8 | 5 | 4 | 2 | 2 | 1.5 | 1 |
| Sigma Level: Zₗₜ | −4.0 | −2.5 | −3.125 | −5.0 | −5.0 | −6.0 | 1.0 | 2.0 | 4.5 |
| Sigma Level: Zₛₜ | −2.5 | −1.0 | −1.625 | −3.5 | −3.5 | −4.5 | 2.5 | 3.5 | 6.0 |

Let us assume the team identified weak areas and took some corrective actions in first week of January, 2003. As a result let us say the average is 65% and Standard deviation 10. The sigma level now works out to be −1.0 (short term sigma level).

The team continues its journey in identifying and taking corrective actions in. In February, let us assume there is no change in the average value of recovery but there is a reduction in standard deviation to 8 as against the value of 10 in January. This is a significant achievement by the team. But the sigma level now works out to be −1.625 (short term sigma level) a lower value as compared to the value of −1.0 in January even though there was a significant improvement in the process namely reduction of the standard deviation or variation. Same is the situation between February and March wherein there is a reduction in variation, but the Sigma level indicates a lower value.

It is really surprising as to how misleading the present method of calculating sigma level could be to the team till the average crosses the target. Even though there is a real improvement (reduction of variation) in February as compared to January and March as compared to February the Sigma level indicates the contrary.

In April, there is both increase in average value of recovery as well as reduction of variation (standard deviation) as compared to March, (increase in average recovery from 65% to 70% and simultaneous reduction of variation from 5 to 4) but the Sigma level remains same. The reason for this is that the area of the distribution of both months on the right and left side of target is the same. Hence the use of discrete method of sigma level calculation to overcome this fallacy is also a gross error and should not be used. In May again, there is both increase in average recovery as well as reduction in variation (standard deviation) as compared to April, but the Sigma level has reduced (from −3.5 to −4.5) even though there is a real improvement (increase in average recovery from 70% to 78% and simultaneous reduction of variation from 4 to 2) in May as compared to April.

Only from the month June onwards, the Sigma Level reflects the true performance because the average recovery has become more than the target value of 90%.

Hence it can be concluded that till the average crosses over (becomes more than) the target, the sigma level is misleading and does not reflect true performance.

Inventor's Novel Methods/Processes to Calculate the Performance for any Project with Project Objective of “Higher the Better” Type Having Target as “Maximum X (Say)”

Method 1: Use of Loss as a Means to Monitor the Progress of Projects

The inventor in his Provisional Application for patent has suggested monitoring performance of the teams/progress of the projects, for cases where project objective is of “Higher the better” type having target as “Maximum X (say)” using the formula
Loss=(Target−Average)²+(Standard Deviation)²

till the average crosses the target to visualize the performance and to use the existing method after the average crosses the target value as shown in table below. Reduction in the loss value indicates process improvement as shown in Table-5 below:

TABLE 5

| Description | Base Level | Jan | Feb | Mar | Apr | May | Jun | Jul | Aug |
|---|---|---|---|---|---|---|---|---|---|
| Average % recovery | 50 | 65 | 65 | 65 | 70 | 78 | 92 | 93 | 94.5 |
| Standard Deviation | 10 | 10 | 8 | 5 | 4 | 2 | 2 | 1.5 | 1 |
| Loss | 1700 | 725 | 689 | 650 | 416 | 148 | — | — | — |
| Sigma Level: Zₗₜ | — | — | — | — | — | — | 1.0 | 2.0 | 4.5 |
| Sigma Level: Zₛₜ | — | — | — | — | — | — | 2.5 | 3.5 | 6.0 |

It can be seen from above table that the loss is continuously reducing from January to May indicating good performance. Once the average has crossed the target value (90 in this case) the normal method of sigma level calculation indicates improvement from June to August.

Hence the inventor in his Provisional Application for Patent strongly suggests the use of his method/process to monitor progress till the average becomes more than the target and then continue with the present existing method. But limitation of this method is that it can be used only when there is increase in average and decrease in standard deviation or vice versa in any month as compared to the previous month's values and cannot be used in cases where there is an increase or decrease in both the average and standard deviation when compared with the previous month's values. To overcome this limitation the inventor suggests the use of method 2 discussed below.

Method 2: Use of Capability Measurement Software Depicting the Capability Measurement DIAGRAM as a Means to Monitor the Progress of Projects

The Applicant or Inventor has invented the “Capability Measurement Diagram” and the related “Moving Loss” to be used to monitor the performance of Six Sigma projects/other projects at any point of time during project progress. The Capability Measurement Diagram for “Higher the better type” CTQ Characteristic is shown in FIG. 2.

As seen in the Capability Measurement Diagram example in FIG. 2, the target for the project is 90% recovery (indicated by a solid black color vertical line). Any point on this black color target line indicates a “Long term Sigma Level”, Zlt=0.0 and corresponding “Short term Sigma Level”, Zst=1.5. Similarly the solid blue color line (colors can be seen only in Software Output) indicates a “Long term Sigma Level”, Zlt=0.5 and “Short term Sigma Level”, Zst=2. The solid gray color line indicates a “Long term Sigma Level”, Zlt=1.5 and “Short term Sigma Level”, Zst=3. The solid magenta color line indicates a “Long term Sigma Level”, Zlt=2.5 and “Short term Sigma Level”, Zst=4 The solid pink color line indicates a “Long term Sigma Level”, Zlt=3.5 and “Short term Sigma Level”, Zst=5. The solid red color line indicates a “Long term Sigma Level”, Zlt=4.5 and “Short term Sigma Level”, Zst=6.

Hence as mentioned earlier the Sigma Level is meaningful when the average value becomes more than the target value of 90% recovery in this example of % recovery (continuous CTQ Characteristic of higher the better type). As discussed earlier when the average value is smaller than the target value the Sigma Level calculated is misleading and fallacious. Hence in this region the inventor suggests calculating “Moving Loss” (in terms of area the logic for which is explained in Page 29) to check if there is improvement or not in the CTQ Characteristic/Objective as compared to the corresponding previous month. Reduction in the “Loss value” for any month when compared to the corresponding previous month's “Loss value” indicates improvement.

The logic used by the Inventor in “Moving Loss” calculations when the CTQ Characteristic is of “Higher the better type” is as given below:
a) There will be a reduction in loss value for any month as compared to the corresponding previous month's loss value if there is an increase in the “Average” or decrease in the “Standard deviation” (with the other remaining constant)
b) There will be a reduction in loss value for any month as compared to the corresponding previous month's loss value if there is a increase in “Average” and reduction in “Standard deviation”.
c) If there is reduction in “Average” or increase in “Standard deviation” (with the other remaining constant) the loss value for that month will be more as compared to the corresponding previous month's loss value.
d) If there is increase in both the “Average” and “Standard deviation” or decrease in both the “Average” and “Standard deviation” the loss value for that month will be more as compared to the corresponding previous month's loss value.

e) If there is reduction in the “Average” and increase in the “Standard deviation” the loss value for that month will be more as compared to the corresponding previous month's loss value. Table-6 shows the “Moving Loss” for different months based on the above logic.

TABLE 6

| | Average | Standard | Sigma Level | Moving |
|---|---|---|---|---|
| Month | Recovery | Deviation | (Short Term) Zst | Loss |
| Base Level: Dec | 50 | 10 | Not Applicable | 550 |
| Jan | 65 | 10 | Not Applicable | 400 |
| Feb | 65 | 8 | Not Applicable | 350 |
| Mar | 65 | 5 | Not Applicable | 275 |
| Apr | 70 | 4 | Not Applicable | 230 |
| May | 78 | 2 | Not Applicable | 174 |
| Jun | 92 | 2 | 2.5 | 50 |
| Jul | 93 | 1.5 | 3.5 | 25 |
| Aug | 94.5 | 1 | 6.0 | 11.11 |

Also as seen in FIG. 2, with reference to the first month's (December in this example) parameter values namely Average % recovery of 50% and a Standard deviation of 10%, there are three colored regions namely red, yellow and green. When compared with the first month's point (December in this example), all points in the red and yellow regions indicate process deterioration. When compared with the first month's point (December in this example), all points in the green region indicates process improvement. The thick broken line represents the desired direction of improvement.

Hence the use of the inventor's methods/processes reflects the true performance in both the above cases and does not mislead the project team or the Management.

Logic Used in Drawing the Capability Measurement Diagram and Moving Loss Calculations When Continuous CTO Characteristic Objective of Interest is of Higher the Better Type

Notations Used:

Target Value: TV
Ideal Value: IV
1^{st} Month Average: AVG1
2^{nd} Month Average: AVG2
. . . and so on till
12^{th} Month Average: AVG12
Lowest Average Value in the data: AVG-Lowest
Highest Average Value in the data: AVG-Highest
Minimum Average value on X-Axis: AVG-Min
Maximum Average value on X-Axis: AVG-Max
1^{st} Month Standard Deviation: SD1
2^{nd} Month Standard Deviation: SD2
. . . and so on till
12^{th} Month Standard Deviation: SD12
Lowest Standard Deviation Value in the data: SD-Lowest
Highest Standard Deviation Value in the data: SD-Highest
Minimum Standard Deviation Value on Y-Axis: SD-Min
Maximum Standard Deviation Value on Y-Axis: SD-Max
Average at SD-Max equivalent to Sigma Level of 2 (Zlt-0.5; Zst=2): AVG-SL2
Average at SD-Max equivalent to Sigma Level of 3 (Zlt=1.5; Zst=3): AVG-SL3
Average at SD-Max equivalent to Sigma Level of 4 (Zlt=2.5; Zst=4): AVG-SL4
Average at SD-Max equivalent to Sigma Level of 5 (Zlt=3.5; Zst=5): AVG-SL5
Average at SD-Max equivalent to Sigma Level of 6 (Zlt=4.5; Zst=6): AVG-SL6
Standard Deviation at Ideal Value (IV) equivalent to Sigma Level of 2 (Zlt=0.5;Zst=2): SD-SL2
Standard Deviation at Ideal Value (IV) equivalent to Sigma Level of 3 (Zlt=1.5;Zst=3): SD-SL3
Standard Deviation at Ideal Value (IV) equivalent to Sigma Level of 4 (Zlt=2.5;Zst=4): SD-SL4
Standard Deviation at Ideal Value (IV) equivalent to Sigma Level of 5 (Zlt=3.5;Zst=5): SD-SL5
Standard Deviation at Ideal Value (IV) equivalent to Sigma Level of 6 (Zlt=4.5;Zst=6): SD-SL6
Loss calculated for the 1^{st} Month: Loss-1
Loss calculated for the 2^{nd} Month: Loss-2
Loss calculated for the Ith Month: Loss-(I)
Long term Sigma Level for 1^{st} Month: Zlt-1
Short term Sigma Level for 1^{st} Month: Zst-1
Long term Sigma Level for 2^{nd} Month: Zlt-2
Short term Sigma Level for 2^{nd} Month: Zst-2
Long term Sigma Level for Ith Month: Zlt-(I)
Short term Sigma Level for Ith Month: Zst-(I)
Average at SD-Max equivalent to 1^{st} Month Data: AVGHigh1
Average at SD-Max equivalent to 2^{nd} Month Data: AVGHigh2
Average at SD-Max equivalent to Ith Month Data: AVGHigh(I)
Standard Deviation at Ideal Value (IV) equivalent to 1^{st} Month Data: SDHigh1
Standard Deviation at Ideal Value (IV) equivalent to 2^{nd} Month Data: SDHigh2
Standard Deviation at Ideal Value (IV) equivalent to Ith Month Data: SDHigh(I)
   Method Used in Drawing the Capability Measurement Diagram
Find out lowest Average value from data entered and denote it as AVG-Lowest
Find out highest Average value from data entered and denote it as AVG-Highest
Find out lowest Standard Deviation value from data entered and denote it as SD-lowest
Find out highest Standard Deviation value from data entered and denote it as SD-Highest
AVG-Max=Ideal Value=IV
AVG-Min=0.75×AVG-Lowest
Draw X-Axis with origin point as AVG-Min and highest point equal to AVG-Max
SD-Max=2×SD-Highest
SD-Min 0.0
Draw Y-Axis with origin point as SD-Min and highest point equal to SD-Max
Show the graduations on both the X-Axis and Y-Axis
Draw a vertical line at X-Axis point AVG-Max and horizontal line at Y-Axis at SD-Max to obtain the boundary box
Draw a vertical line (Red Color) at X-Axis point TV till it meets the upper horizontal boundary line and denote it as Zlt=0 and Zst=1.5
AVG-SL2=TV+0.5×SD-Max
If AVG-SL2<IV OR AVG-SL2=IV then
Draw an inclined vertical line joining X-Axis point TV and AVG-SL2 (at SD-Max) and denote it as Zlt=0.5 and Zst=2.0
Else If AVG-SL2>IV then
SD-SL2=(SD-Max/(0.5×SD-Max))×(IV-TV)
Draw an inclined vertical line joining X-Axis point TV and SD-SL2 (at Ideal Value) and denote it as Zlt=0.5 and Zst=2.0
AVG-SL3=TV+1.5×SD-Max
If AVG-SL3<IV OR AVG-SL3=IV then
Draw an inclined vertical line joining X-Axis point TV and AVG-SL3 (at SD-Max) and denote it as Zlt=1.5 and Zst=3.0
Else If AVG-SL3>IV then
SD-SL3=(SD-Max/(1.5×SD-Max))×(IV-TV)
Draw an inclined vertical line joining X-Axis point TV and SD-SL3 (at Ideal Value) and denote it as Zlt=1.5 and Zst=3.0
AVG-SL4=TV+2.5×SD-Max
If AVG-SL4<IV OR AVG-SL4=IV then
Draw an inclined vertical line joining X-Axis point TV and AVG-SL4 (at SD-Max) and denote it as Zlt=2.5 and Zst=4.0
Else If AVG-SL4>IV then
SD-SL4=(SD-Max/(2.5×SD-Max))×(IV-TV)
Draw an inclined vertical line joining X-Axis point TV and SD-SL4 (at Ideal Value) and denote it as Zlt=2.5 and Zst=4.0
AVG-SL5=TV+3.5×SD-Max
If AVG-SL5<IV OR AVG-SL5=IV then
Draw an inclined vertical line joining X-Axis point TV and AVG-SL5 (at SD-Max) and denote it as Zlt=3.5 and Zst=5.0
Else If AVG-SL5>IV then
SD-SL5=(SD-Max/(3.5×SD-Max))×(IV-TV)
Draw an inclined vertical line joining X-Axis point TV and SD-SL5 (at Ideal Value) and denote it as Zlt=3.5 and Zst=5.0
AVG-SL6=TV+4.5×SD-Max
If AVG-SL6<IV OR AVG-SL6=IV then
Draw an inclined vertical line joining X-Axis point TV and AVG-SL6 (at SD-Max) and denote it as Zlt=4.5 and Zst=6.0
Else If AVG-SL6>IV then
SD-SL6=(SD-Max/(4.5×SD-Max))×(IV-TV)
Draw an inclined vertical line joining X-Axis point TV and SD-SL6 (at Ideal Value) and denote it as Zlt=4.5 and Zst=6.0
   Method of Plotting the Input Data Points on Diagram
Mark a point at AVG1& SD1 and name it as 1^{st} Month (Say May if it is entered as first month in input screen)
Mark a point at AVG2& SD2 and name it as 2^{nd} Month (Say June if it is entered as second month in input screen)
. . . and so on till
the last month is entered in input screen.
   Join all the points joining from the first month till the last month.
   Logic Used in Moving Loss Calculation for Different Months
   For 1^{st} Month Data:
If AVG1<TV then
Loss-1=(SD-Max×(IV-TV))+(TV-AVG1)×SD1
Else If AVG1=TV then
Zlt-1=0.0; Zst-1=1.5 and
Loss-1=(SD-Max×(IV-TV))
Else If AVG1>TV then
BEGIN
   Zlt-1=(AVG1-TV)/SD1 and
   Zst-1=Zlt-1+1.5 and
   AVGHigh1=TV+Zlt-1×SD-Max and
   If AVGHigh1<IV OR AVGHigh1=IV then
   Loss-1=(SD-Max×(IV-TV))−(0.5×(AVGHigh1-TV)×SD-Max)
   Else If AVGHigh1>IV
SDHigh1=(SD-Max/(Zlt-1×SD-Max))×(IV-TV) and
   Loss-1=0.5×SDHigh1×(IV-TV)
END.
   For 2^{nd} Month Data:
If AVG2<TV and AVG1>TV OR AVG1=TV then
Loss-2=(SD-Max×(IV-TV))+(TV-AVG2)×SD2
Else If AVG2<TV and AVG2=AVG1 then
Loss-2=(SD-Max×(IV-TV))+(TV-AVG2)×SD2
Else If AVG2<TV and SD2=SD1 then
Loss-2=(SD-Max×(IV-TV))+(TV-AVG2)×SD2
Else If AVG2<AVG1 and AVG1<TV and SD2<SD1 then
Loss-2=Loss-1+(AVG1-AVG2)×SD1−(0.5×(AVG1-AVG2)×(SD1-SD2))
Else If AVG2<AVG1 and AVG1<TV and SD2>SD1 then
Loss-2=(SD-Max×(IV-TV))+((TV-AVG2)×SD2)
Else If AVG2<TV and AVG2>AVG1 and SD2>SD1 then
Loss-2=Loss-1+((SD2-SD1)×(TV-AVG1))−(0.5×(SD2-SD1)×(AVG2-AVG1))
Else If AVG2<TV and AVG2>AVG1 and SD2<SD1 then
Loss-2=(SD-Max×(IV-TV))+((TV-AVG2)×SD2)
Else If AVG2=TV then
Zlt-2=0.0; Zst-2=1.5 and
Loss-2=(SD-Max×(IV-TV))
Else If AVG2>TV then
BEGIN
   Zlt-2=(AVG2-TV)/SD2 and
   Zst-2=Zlt-2+1.5 and
   AVGHigh2=TV+Zlt-2×SD-Max and
   If AVGHigh2<IV OR AVGHigh2=IV then
   Loss-2=(SD-Max×(IV-TV))−(0.5×(AVGHigh2-TV)×SD-Max)
   Else If AVGHigh2>IV
   SDHigh2=(SD-Max/(Zlt-2×SD-Max))×(IV-TV) and
   Loss-2=0.5×SDHigh2×(IV-TV)
END.
   For 3^{rd} Month till last Month Data:
If AVG(I)<TV and AVG(I-1)>TV OR AVG(I-1)=TV then
Loss-(I)=(SD-Max×(IV-TV))+(TV-AVG(I))×SD(I)
Else If AVG(I)<TV and AVG(I)=AVG(I-1) then
Loss-(I)=(SD-Max×(IV-TV))+(TV-AVG(I))×SD(I)
Else If AVG(I)<TV and SD(I)=SD(I-1) then
Loss-(I)=(SD-Max×(IV-TV))+(TV-AVG(I))×SD(I)
Else If AVG(I)<AVG(I-1) and AVG(I-1)<TV and SD(I)<SD(I-1) then
Loss-(I)=Loss-(I-1)+(AVG(I-1)−AVG(I))×SD(I-1)−(0.5×(AVG(I-1)−AVG(I))×(SD(I-1)−SD(I)))
Else If AVG(I)<AVG(I-1) and AVG(I-1)<TV and SD(I)>SD(I-1) then
Loss-(I)=(SD-Max×(IV-TV))+((TV-AVG(I))×SD(I))
Else If AVG(I)<TV and AVG(I)>AVG(I-1) and SD(I)>SD(I-1) then
Loss-(I)=Loss-(I-1)+((SD(I)−SD(I-1))×(TV-AVG(I-1)))−(0.5×(SD(I)−SD(I-1))×(AVG(I)−AVG(I-1)))
Else If AVG(I)<TV and AVG(I)>AVG(I-1) and SD(I)<SD(I-1) then
Loss-(I)=(SD-Max×(IV-TV))+((TV-AVG(I))×SD(I))
Else If AVG(I)=TV then
Zlt-(I)=0.0; Zst-(I)=1.5 and
Loss-(I)=(SD-Max×(IV-TV))
Else If AVG(I)>TV then
BEGIN
   Zlt-(I)=(AVG(I)−TV)/SD(I) and
   Zst-(I)=Zlt-(I)+1.5 and
   AVGHigh(I)=TV+Zlt-(I)×SD-Max and
   If AVGHigh(I)<IV OR AVGHigh(I)=IV then
   Loss-(I)=(SD-Max×(IV-TV))−(0.5×(AVGHigh(I)−TV)×SD-Max)
   Else If AVGHigh(I)>IV
   SDHigh(I)=(SD-Max/(Zlt-(I)×SD-Max))×(IV-TV) and
   Loss-(I)=0.5×SDHigh(I)×(IV-TV)
END.
   Method to Operate the Capability Measurement Software Given in CD Contents of this Compact Disc:
1. README (THIS FILE)
2. “JAVA SOFTWARE JDK 1.3.1” FOLDER CONTAINING JAVA SOFTWARE VERSION 1.3 for WINDOWS
3. “JAVA CODE FILES” FOLDER CONTAINING THE CODE
4. “JAVA CLASS FILES” FOLDER CONTAINING COMPILED CLASS FILES
   Instructions for Running the “Capability Measurement Software”
   Method 1:
A. DOWNLOAD JAVA VERION 1.3 FOR WINDOWS
B. COPY ALL CLASS FILES TO THE BIN FOLDER IN THE DOWNLOADED JAVA SOFTWARE
C. IN THE DOS PROMPT GO TO BIN FOLDER
D. TYPE java AddressPage AND PRESS ENTER
E. PRESS CONTINUE BUTTON ON THE INITIAL SCREEN
F. SELECT DISCRETE OR CONTINUOUS ON THE INPUT SCREEN
G. IF DISCRETE IS SELECTED THEN SELECT EITHER DEFECTS OR DEFECTIVES
H. IF CONTINUOUS IS SELECTED THEN SELECT EITHER LOWER THE BETTER OR HIGHER THE BETTER OR NOMINAL THE BEST
I. YOU ARE READY TO INPUT YOUR DATA
J. PRESS OK BUTTON AT THE BOTTOM TO GET OUTPUT SCREEN
K. PRESS OK TO EXIT OUTPUT SCREEN
L. IF YOU WISH TO CONTINUE WITH ANOTHER DATA SET REPEAT FROM STEP D.
   Method 2:
A. IN THE DOS PROMPT GO TO “BIN” FOLDER IN “JAVA SOFTWARE JDK 1.3.1” FOLDER ON THE CD
B. TYPE java AddressPage AND PRESS ENTER
C. PRESS CONTINUE BUTTON ON THE INITIAL SCREEN
D. SELECT DISCRETE OR CONTINUOUS ON THE INPUT SCREEN
E. IF DISCRETE IS SELECTED THEN SELECT EITHER DEFECTS OR DEFECTIVES
F. IF CONTINUOUS IS SELECTED THEN SELECT EITHER LOWER THE BETTER OR HIGHER THE BETTER OR NOMINAL THE BEST
G. YOU ARE READY TO INPUT YOUR DATA
H. PRESS OK BUTTON AT THE BOTTOM TO GET OUTPUT SCREEN
I. PRESS OK TO EXIT OUTPUT SCREEN
J. IF YOU WISH TO CONTINUE WITH ANOTHER DATA SET REPEAT FROM STEP B.

1. Invention of Capability Measurement Diagram and Moving Loss method built into Capability Measurement Software to monitor the progress of Six Sigma/other projects during implementation when Critical To Quality Characteristic is of
“Lower the better” type
“Higher the better” type
